(19) United States
(12) Patent Application Publication
(10) Pub. No.: US 2017/0063614 A1
(43) Pub. Date: Mar. 2, 2017

(54) PROVISIONING NETWORK PORTS AND VIRTUAL LINKS

(71) Applicant: Megaport (Services) Pty Ltd., Fortitude Valley (AU)

(72) Inventor: Patrik Jonathan Hartwig, Brisbane (AU)

(21) Appl. No.: 14/978,453

(22) Filed: Dec. 22, 2015

Related U.S. Application Data
(60) Provisional application No. 62/209,583, filed on Aug. 25, 2015.

(51) Int. Cl. H04L 12/24

(52) U.S. Cl. CPC H04L 41/0806; H04L 41/22; H04L 41/0886

(57) ABSTRACT

Systems, methods, and computer-readable storage media are provided for provisioning network ports and virtual links. In some example embodiments, a system can receive a first request to establish a network port. The network port can comprise an interface for a dedicated network connection between a first endpoint and a remote network. The system can also receive a second request to attach to the network port a virtual link between the first endpoint and one or more second endpoints of the remote network. Next, the system can generate configuration data for the network port and the virtual link and, based on the configuration data, configure one or more physical network resources for provisioning the virtual link between the first endpoint and the one or more second endpoints.

### RELATED APPLICATIONS

This application claims priority to U.S. Provisional Patent Application No. 62/209,583, filed on Aug. 25, 2015, the content of which is incorporated herein by reference in its entirety.

### TECHNICAL FIELD

The present technology pertains to computer networking, and more specifically to provisioning of network ports and virtual links for a computer-based network.

### BACKGROUND

Recently, consumers and enterprises have increasingly shifted toward cloud-based networking for communication and data services. This shift has created challenges due to an increasing variety of network configurations available from a growing number of cloud service providers. For example, when implementing a cloud-based networking solution, it can be extremely difficult to understand the various network configurations and options available from the different cloud service providers. Each cloud service provider can have its own set of options for implementing its respective solutions, and each solution may differ in costs and accompanying services. This multitude of options from various cloud service providers can cause confusion due to uncertainty in pricing and network services included in the pricing. Comparing the various cloud-based solutions may also be a difficult and time-consuming process. Even once a suitable solution is identified, implementing that solution can be an onerous and time-consuming process coupled with its own set of difficult challenges.

### BRIEF DESCRIPTION OF THE DRAWINGS

In order to describe the manner in which the above-recited features and other advantages of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting its scope, the principles herein are described and explained with additional specificity and detail through the use of the accompanying drawings in which:

FIG. 1A illustrates an example cloud architecture in accordance with some embodiments;

FIG. 1B illustrates an example cloud service management system;

FIG. 1C illustrates a diagram of an example interconnection model 172 between clouds or networks, in accordance with some embodiments;

FIG. 2A illustrates a schematic diagram of an example system for interconnecting networks;

FIG. 2B illustrates an example configuration of a fabric for provisioning services and interconnecting networks;

FIG. 2C illustrates a second example configuration of a fabric for provisioning services and interconnecting networks;

FIG. 3 illustrates an example approach for provisioning network ports and virtual links which may be utilized by some embodiments of the present technology;

FIG. 4 illustrates an example approach for provisioning network ports and virtual links which may be utilized by some embodiments of the present technology;

FIG. 5 illustrates an example approach for provisioning network ports and virtual links which may be utilized by some embodiments of the present technology;

FIG. 6 illustrates an example approach for provisioning network ports and virtual links which may be utilized by some embodiments of the present technology;

FIG. 7 illustrates an example approach for provisioning network ports and virtual links which may be utilized by some embodiments of the present technology;

FIG. 8 illustrates an example approach for provisioning network ports and virtual links which may be utilized by some embodiments of the present technology;

FIG. 9 illustrates an example approach for provisioning network ports and virtual links which may be utilized by some embodiments of the present technology;

FIG. 10 illustrates an example approach for provisioning network ports and virtual links which may be utilized by some embodiments of the present technology;

FIG. 11 illustrates example approaches for provisioning network ports and virtual links which may be utilized by some embodiments of the present technology;

FIG. 12 illustrates example approaches for provisioning network ports and virtual links which may be utilized by some embodiments of the present technology;

FIG. 13 illustrates example approaches for provisioning network ports and virtual links which may be utilized by some embodiments of the present technology;

FIG. 14 illustrates example approaches for provisioning network ports and virtual links which may be utilized by some embodiments of the present technology;

FIG. 15 illustrates example approaches for provisioning network ports and virtual links which may be utilized by some embodiments of the present technology;

FIG. 16 an example approaches for provisioning network ports and virtual links which may be utilized by some embodiments of the present technology;

FIG. 17 illustrates an example process which may be utilized by some embodiments of the present technology;

FIG. 18 illustrates an example process which may be utilized by some embodiments of the present technology; and

FIG. 19 illustrates an example system architecture according to some embodiments.

A component or a feature that is common to more than one drawing is indicated with the same reference number in each of the drawings.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The approaches set forth herein can allow users to provision network services through a control interface for creating network ports interconnecting devices and networks, such as network carriers, service providers, cloud providers, and so forth. The network ports can be configured through the control interface, which can provide an interactive display for establishing the network ports interconnecting the devices and networks. The control interface can allow users to add and purchase network services, edit the network services, remove the network services, or monitor the network services. The purchased network services can be automatically configured by interconnecting various networks or clouds based on the settings specified via the control interface.

The approaches set forth herein can provide a software defined network (SDN) architecture over a network or fabric to allow automated network configuration through software. Customers and partners can obtain full access to networks and resources to directly provision and manage services and networks via the web, an application, or an application programming interface (API), for example. The approaches set forth herein allow for simple, on-demand configuration of services, networks, and/or resources, via a control interface, such as a graphical user interface, command-line interface, application, API, etc. The SDN architecture can be accessible through a public API that can be used to obtain access to services in different geographic locations via the control interface. The API can be agnostic to the programming languages used by clients and can thus be implemented in a wide variety of environments (e.g., JSON, HTTPS, Perl, REST-ful, Swagger, etc.).

Disclosed are systems, methods, and computer-readable media for provisioning network ports interconnecting networks and devices. In some examples, a system can receive a first request to establish a network port comprising an interface for a dedicated network connection between a first endpoint and a remote network. The network port can be associated with one or more virtual links for connecting the first endpoint and the remote network. The first endpoint can be, for example, an enterprise, a consumer, a network, a carrier, a cloud, a datacenter, etc. Moreover, the remote network can include a campus, a datacenter, a network, a cloud, etc. The remote network can also include one or more physical and/or virtual network resources that can be accessed via the network ports. A virtual link, as used herein, can include a virtual circuit, a virtual line (e.g., virtual leased line, a virtual private line, etc.), a pseudowire, and/or any other virtual path, link, tunnel, or network.

The system can also receive a second request to attach to the network port a virtual link between the first endpoint and one or more second endpoints of the remote network. For example, the system can receive a request to attach to the network port a virtual link between a first endpoint, such as an enterprise network or a cloud, and a second endpoint, such as a cloud service provider a public network. The virtual link can provide a virtual point-to-point connection, such as a pseudowire (e.g., MPLS or IP pseudowire) or a tunnel (e.g., virtual tunnel or circuit), for example. The one or more second endpoints can include a network, a carrier, a cloud, a datacenter, a campus, etc.

The system can then generate configuration data for the network port and the virtual link and, based on the configuration data, configure one or more physical network resources for provisioning the virtual link between the first endpoint and the one or more second endpoints. The system can generate the configuration data and configure the physical network resources automatically in response to the first and second requests. The system can also generate the configuration data and configure the physical network resources automatically in response to a purchase event, such as an input from a user for purchasing the network port, the virtual link, and/or a service associated with the one or more second endpoints. The purchase can be facilitated via a control interface, such as a graphical user interface, command-line interface, application, API, etc., which can be used by a user to submit the first and second requests, as well as any parameters associated with the network port, the virtual link, and/or the service. The purchase can be made on a subscription basis, on a schedule, a term, or any other payment model, such as pay per usage.

By configuring the physical network resources, the system can establish the virtual link between the first endpoint and the one or more second endpoints. The system can also enable the user to obtain access to resources associated with the one or more second endpoints based on the virtual link.

Some embodiments of the present technology can provide a gateway or interconnection to multiple private or public networks, cloud service providers, internet service providers, among other networks or services. Examples of cloud service providers and cloud networks include AWS® from Amazon.com®, Inc. of Seattle, Wash., Azure® from Microsoft® Corp. of Redmond, Wash., and Google Cloud Platform® from Google® Inc. of Mountain View, Calif. The gateway or interconnection may allow a user to access or interconnect one or more cloud providers through a web site, a command-line interface, a computing application (for example, a mobile computing device application), an API, or other control interface. The setup can be automated through the control interface with minimal manual configuration.

Embodiments of the present technology can remove the need for a user to purchase his/her own hardware, software, and other resources for implementing a network, such as servers, routers, switches, firewalls, deep packet inspectors, traffic monitors, load balancers, wide area network (WAN) optimizers, security appliances, domain name system (DNS), and other network resources. Embodiments of the present technology can also eliminate manual configuration of the user's network to connect to other networks, clouds, or providers. For instance, a user may wish to utilize services of multiple cloud service providers based on considerations such as cost, geographic proximity, high availability, load balancing, and data replication, among other factors. Different cloud service providers may charge different rates to use bandwidth on their respective cloud networks. The user may desire a change in service provider for some or all of his/her network ports in order to reduce costs. The user may also wish to increase resources or bandwidth by, for example, cloud bursting to other clouds or providers. This all can be performed through a website, application, API, or other control interface by creating one or more network ports and attaching specific services, such as cloud or network services from respective providers.

In some embodiments, real time pricing updates can affect a user's desire to add or remove network services. If pricing from the multiple public cloud service providers changes, embodiments of the present technology may provide real-time updates on pricing for various services related to the multiple public cloud service providers. For example, real time pricing may be provided to a user for connecting to one or more public cloud networks. The user may select from various options such as, for instance, a particular public cloud provider, bandwidth on a public cloud network, location of a physical server associated with a public cloud network, or routing path(s) of data between endpoints.

In some embodiments, a user can utilize a control interface, such as a graphical user interface on a web site, a command-line interface, a desktop application, a mobile device application, or API, etc., to choose various network services in an a-la-carte manner for his/her network. For instance, the user may be able to select more bandwidth from the same public cloud service provider the user is currently connected with, a different cloud service provider, or both. The user may select one or more network configurations such as additional bandwidth from two different cloud service providers. The user's selected network configuration may be highlighted and the respective costs for the additional services can be displayed to the user so the user can quickly and conveniently view the cost to add the additional services without having to research the protocols, requirements, configurations, etc., of each of the cloud service providers.

In some embodiments, a user may be able to filter network configurations by, for example, price, bandwidth, rate limit, or any other factor. Also, after a user has selected a network configuration, the user may save the selected network configuration template for future use without necessarily purchasing the selected network configuration. This can be useful for pricing analysis, as it allows a quick and convenient comparison of costs and services among different network configurations of various cloud service providers.

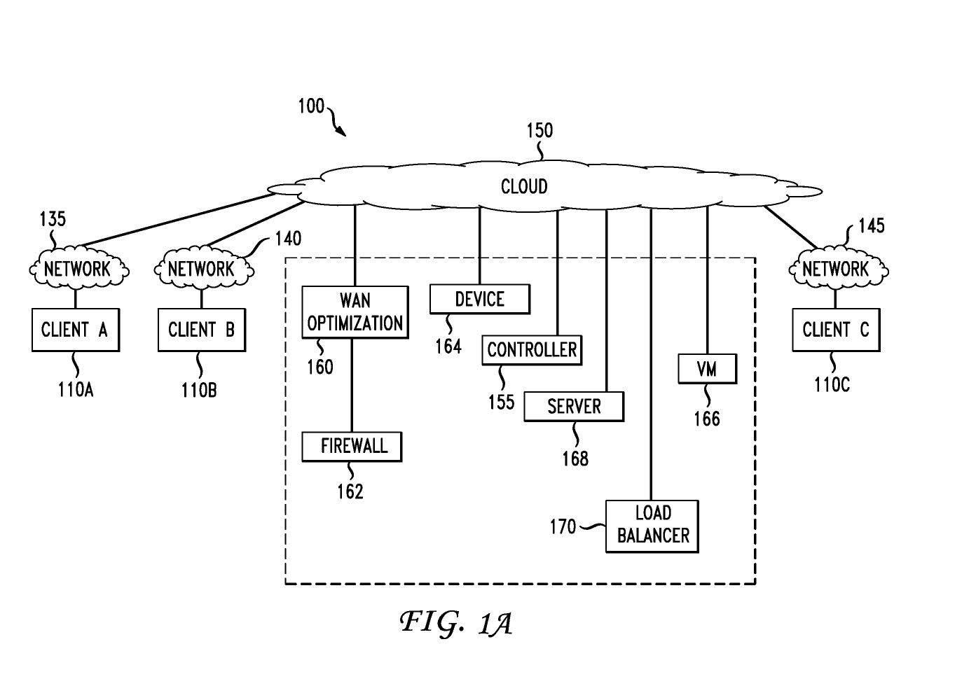

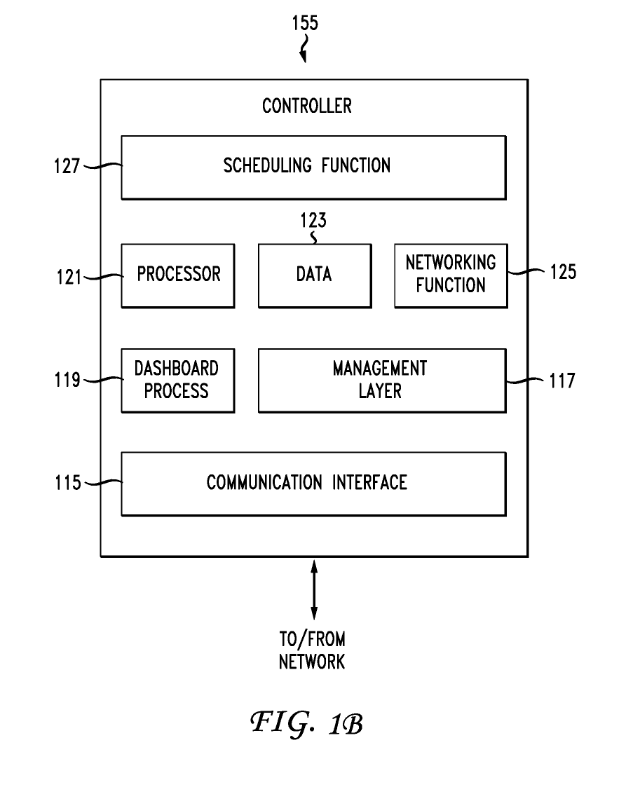

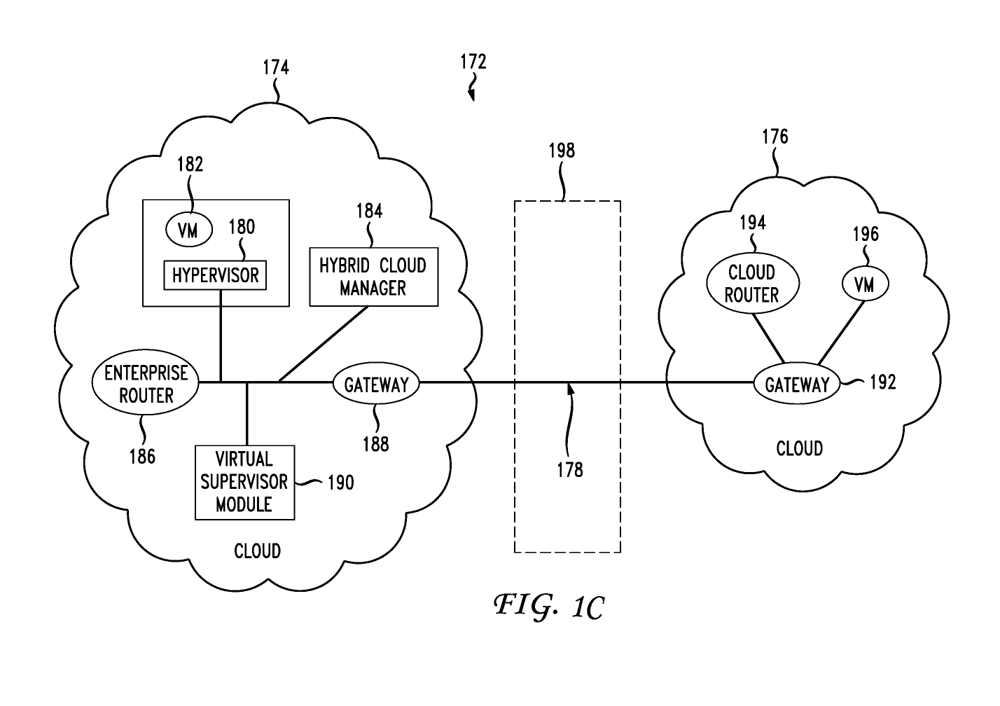

The present technology can be utilized in one or more cloud computing environments. FIG. 1A illustrates an example cloud architecture 100 that can be utilized in accordance with some embodiments. Cloud 150 can be a public, private, and/or hybrid cloud system which may include one or more public and private cloud networks in communication with each other. Cloud 150 can include resources, such as one or more Firewalls 162; Load Balancers 170; WAN optimization platforms 160; devices 164, such as switches, routers, intrusion detection systems, etc.; servers 168, such as a primary use network server, a data backup server, dynamic host configuration protocol (DHCP) server, a domain naming system (DNS) server, a storage server, an authentication server, etc.; virtual machines (VMs) 166; controllers 155, such as a communications controller or management device.

Cloud resources can be physical, software, virtual, or any combination thereof. For example, a cloud resource can include a server running one or more VMs or hosting one or more databases. Moreover, cloud resources can be provisioned based on requests (e.g., client or tenant requests), schedules, triggers, events, signals, messages, alerts, agreements, necessity, subscriptions, purchases, or any other factor. Cloud 150 can provision various types of resources or services, such as network recovery services, application services, software development services, database services, storage services, management services, monitoring services, configuration services, administration services, backup services, disaster recovery services, bandwidth or performance services, intrusion detection services, VPN services, or any type of services to any device, server, network, client, or tenant. Other example service models include software as a service, infrastructure as a service, platform as a service, backend as a service, desktop as a service, or information technology management as a service.

In addition, cloud 150 can handle traffic and manage resources and configurations. For example, cloud 150 can provide network routing/re-routing services, network data backup services, configuration services, such as automated deployments, automated wireless configurations, automated policy implementations, and the like. In some embodiments, the cloud 150 can collect data about a client or network and generate configuration settings for specific service, device, or networking deployments. For example, the cloud 150 can generate security policies, subnetting and routing schemes, forwarding schemes, NAT settings, VPN settings, and/or any other type of configurations. The cloud 150 can then push or transmit the necessary data and settings to specific devices or components to manage a specific implementation or deployment. For example, the cloud 150 can generate VPN settings, such as IP mappings, port number, and security information, and send the VPN settings to specific, relevant device(s) or component(s) identified by the cloud 150 or otherwise designated. The relevant device(s) or component(s) can then use the VPN settings to establish a VPN tunnel according to the settings. As another example, the cloud 150 can generate and manage network diagnostic tools or graphical user interfaces, or automate the interconnection between multiple networks and resources.

Furthermore, cloud 150 can provide specific services for clients—namely, client A 110A, client B 110B, and client C 110C. For example, cloud 150 can deploy a network or specific network component, configure links or devices, automate services or functions, or provide any other services for the clients. Other non-limiting example services performable by cloud 150 can include network administration services, network monitoring services, content filtering services, application control, WAN optimization, firewall services, gateway services, storage services, protocol configuration services, wireless deployment services, interconnection services, network services, and so forth.

To this end, the clients can connect with cloud 150 through networks 135, 140, and 145, respectively. More specifically, client A 110A, client B 110B, and client C 110C can each connect with cloud 150 through networks 135, 140, and 145, respectively, in order to access resources from cloud 150, communicate with cloud 150, or receive any services from cloud 150. Networks 135, 140, and 145 can each refer to a public network, such as the Internet; a private network, such as a LAN; a combination of networks; or any other network, such as a VPN.

Moreover, the clients can each include one or more networks. For example, client A 110A, client B 110B, and client C 110C can each include one or more LANs and VLANs. A client can represent a branch network, such as a LAN, or multiple branch networks, such as multiple remote networks. For example, client A 110A can represent a single LAN network or branch, or multiple branches or networks, such as a branch building, office, or campus network in Los Angeles and another branch building, office, or campus network in New York. Client A 110A, client B 110B, and client C 110C can thus include campus networks, enterprise networks, provider networks, datacenters, etc. If a client includes multiple branches or networks, the multiple branches or networks can each have a designated connection to the cloud 150. For example, each branch or network can maintain a tunnel to the cloud 150. Alternatively, all branches or networks for a specific client can connect to the cloud 150 via one or more specific branches or networks. For example, traffic for the different branches or networks of a client can be routed through one or more specific branches or networks. Further, client A 110A, client B 110B, and client C 110C can each include one or more routers, switches, appliances, client devices, VMs, or any other devices.

Each client can also maintain links between branches. For example, client A can have two branches, and the branches can maintain a link between each other. Thus, in some cases, branches can maintain a tunnel between each other, such as a VPN tunnel. Moreover, the link or tunnel between branches can be generated and/or maintained by the cloud 150. For example, the cloud 150 can collect network and address settings for each branch and use those settings to establish a tunnel between branches.

Cloud 150 can maintain information about each client network, in order to provide or support specific services for each client, such as network traffic monitoring, network traffic routing/re-routing, security, or network services. Cloud 150 can also maintain one or more links or tunnels to the clients. For example, cloud 150 can maintain a virtual circuit to one or more devices in client A's network.

The cloud 150 can also monitor device and network health and status information for client A 110A, client B 110B, and client C 110C. To this end, client A 110A, client B 110B, and client C 110C can synchronize information with cloud 150. Cloud 150 can also manage and deploy services for the clients. For example, cloud 150 can collect network information about client A 110A and generate network and device settings to automatically deploy a service for client A 110A. In addition, cloud 150 can update device, network, and service settings for the clients. Cloud 150 can also interconnect a client with another network or cloud either directly or indirectly through the cloud 150, for example.

Those skilled in the art will understand that the cloud architecture 150 can include any number of nodes, devices, links, networks, or components. In fact, embodiments with different numbers and/or types of clients, networks, nodes, cloud components, servers, software components, devices, virtual or physical resources, configurations, topologies, services, appliances, deployments, or network devices are also contemplated herein. Further, cloud 150 can include any number or types of resources, which can be accessed and utilized by clients or tenants. The illustration and examples provided herein are intended for clarification of some embodiments of the present technology.

Moreover, as far as communications, packets (e.g., traffic and/or messages) can be exchanged among the various nodes and networks in the cloud architecture 100 using specific network protocols. In particular, packets can be exchanged using wired protocols, wireless protocols, security protocols, OSI-Layer specific protocols, labels, or any other protocols. Some non-limiting examples of protocols can include Session Initiation Protocol (SIP), protocols from the Internet Protocol Suite, such as TCP/IP; OSI (Open Systems Interconnection) protocols, such as L1-L7 protocols; routing protocols, such as RIP, IGP, BGP, STP, ARP, OSPF, EIGRP, NAT; or any other protocols or standards, such as HTTP, SSH, SSL, RTP, FTP, SMTP, POP, PPP, NNTP, IMAP, Telnet, SSL, SFTP, WIFI, Bluetooth, VTP, ISL, IEEE 802 standards, L2TP, IPSec, etc. In addition, various hardware and software components or devices can be implemented to facilitate communications both within a network and between networks. The various hardware and software components or devices can also be referred to as nodes and some examples are switches, hubs, routers, access points (APs), antennas, network interface cards (NICs), modules, cables, firewalls, servers, repeaters, sensors, and the like.

FIG. 1B illustrates a schematic block diagram of an example controller 155. Controller 155 can serve as a cloud service management system for cloud 150. In particular, controller 155 can manage cloud operations, client communications, service provisioning, network configuration and monitoring, and the like. For example, controller 155 can manage cloud service provisioning or deployment, such as cloud storage, media, streaming, security, or administration services. Controller 155 can also manage VMs; networks, such as client networks; service provisioning; virtual circuits between networks or clouds; interfaces; network ports; and so forth.

Controller 155 can include several subcomponents, including hardware and software components such as a scheduling function 127, a processor 121, a dashboard process 119, data storage 123, a networking function 125, a management layer 117, and a communication interface 115. The various subcomponents can be implemented as hardware and/or software components (e.g., processor, memory, modules, logic, virtual workload, data structures, etc.). Moreover, although FIG. 1B illustrates one example configuration of the various components of controller 155, those of skill in the art will understand that the components can be configured in a number of different ways and can include any other type and number of components. For example, networking function 125 and management layer 117 can belong to one software module or multiple separate modules. Other modules can be combined or further divided up into more subcomponents.

Scheduling function 127 can manage scheduling of procedures, events, services, or communications. For example, scheduling function 127 can schedule when resources should be allocated from cloud 150. As another example, scheduling function 127 can schedule when specific instructions or commands should be transmitted to a network (e.g., one or more client devices). Scheduling function 127 can provide scheduling for operations performed or executed by the various subcomponents of controller 155. Scheduling function 127 can also schedule resource slots, virtual machines, bandwidth, device activity, status changes, nodes, updates, policies, circuits, services, and the like.

Dashboard process 119 can provide an interface or front end where clients can access, consume, purchase, configure, remove, manage, and generally monitor cloud and network services. For example, dashboard process 119 can provide a web-based frontend where clients can configure client devices or networks that are cloud-managed, provide client preferences, configure policies, enter data, upload statistics, configure interactions or operations, etc. As another example, dashboard process 119 can provide an interactive display where users can interconnect their network or device with one or more networks or clouds, such as cloud 150 and a separate cloud or datacenter, for example.

Dashboard process 119 can provide visibility information, such as views of client networks or devices, and even provide diagnostic information, e.g., dashboard process 119 can provide a view of the status or conditions of the client's network, the operations taking place, services, performance, a topology or layout, specific network devices, protocols implemented, running processes, errors, notifications, alerts, network structure, ongoing communications, data analysis, etc.

Dashboard process 206 can provide a graphical user interface (GUI) for the client to monitor the client's network(s), devices, statistics, services, connections, account(s), configurations, errors, notifications, etc., and even make modifications or setting changes through the GUI. The GUI can depict charts, lists, tables, tiles, network trees, maps, topologies, symbols, structures, or any graphical object or element. In addition, the GUI can use color, font, shapes, or any other characteristics to depict scores, alerts, or conditions. Dashboard process 206 can also handle user or client requests. For example, the client can enter a request through a corresponding GUI to establish or configure a virtual circuit or service, modify configurations, add resources to a current service, purchase or cancel a service, etc.

Data storage 123 can include any data or information, such as management data, statistics, settings, preferences, profile data, account data, transactions, logs, notifications, attributes, configuration parameters, client information, network information, and the like. For example, controller 155 can collect network statistics from a client (e.g., client A 110A) and store the statistics in data storage 123. Data storage 123 can also include performance and/or configuration information. This way, controller 155 can use such data to perform management or service operations for the client. Data storage 123 can be a physical storage or memory device, a database, a folder, a disk, or any storage medium on controller 155 or accessible to controller 155 (e.g., directly or indirectly).

Networking function 125 can be a module, application, appliance, logic, processor, or function capable of performing network operations. Networking function 125 can thus perform networking calculations, such as network addressing, or networking service or operations, such as auto virtual circuit configuration or traffic routing/re-routing. For example, networking function 125 can perform filtering functions, switching functions, failover functions, high availability functions, network or device deployment functions, resource allocation functions, messaging functions, traffic analysis functions, port configuration functions, mapping functions, packet manipulation functions, path calculation functions, loop detection, cost calculation, error detection, or otherwise manipulate data or networking devices. Networking function 125 can handle networking requests from other networks or devices and establish links between devices. Networking function 125 can also perform queueing, messaging, or protocol operations.

Management layer 117 can include logic to perform management operations. For example, management layer 117 can include the logic to allow the various components of controller 155 to interface and work together. Management layer 117 can also include the logic, functions, software, and procedure to allow controller 155 to perform monitoring, management, control, deployment, configuration, and administration operations of other devices, networks, clouds, providers, clients (e.g., clients 110A-C); or cloud 150 operations and/or applications, services provided to clients, or any other component or procedure. Management layer 117 can include the logic to operate controller 155 and perform particular services configured on controller 155.

Moreover, management layer 117 can initiate, enable, or launch other instances in controller 155 and/or cloud 150. In some embodiments, management layer 117 can also provide authentication and security services for cloud 150, clients (e.g., 110A-C), controller 155, and/or any other device or component. Further, management layer 117 can manage nodes, resources, VMs, settings, policies, protocols, communications, services, clouds, datacenters, networks, and the like. In some embodiments, management layer 117 and networking function 125 can be part of the same module. However, in some embodiments, management layer 117 and networking function 125 can be separate layers and/or modules.

Communications interface 115 allows controller 155 to communicate with other devices or networks, such as clients 110A-C or other clouds or providers.

Communications interface 115 can be a network interface card (NIC), and can include wired and/or wireless capabilities. Communications interface 115 allows controller 155 to send and receive data from other devices and networks. In some embodiments, controller 155 can include multiple communications interfaces for redundancy or failover. For example, controller 155 can include dual NICs for connection redundancy or for multiple lines or channels.

FIG. 1C illustrates a diagram of an example interconnection model 172 between clouds or networks, in accordance with some embodiments. The interconnection model 172 can include a first cloud 174 (e.g., private and/or public cloud, enterprise datacenter, network, endpoint, campus, etc.) and a second cloud 176, which can be directly connected or separated by one or more networks, such as the Internet. In some embodiments, the first cloud 174 can be connected to the second cloud 176 via portions of the Internet and dedicated paths associated with the first cloud and/or the second cloud.

The first cloud 174 and second cloud 176 can be connected via a communication link 178 between cloud gateway 188 and cloud gateway 192. Data packets and traffic can be exchanged among the devices of the clouds 174, 176 using predefined network communication protocols. The communication link 178 can be a dedicated virtual or physical line, such as a virtual circuit, a pseudowire, a virtual private network, a point-to-point network, and so forth. Moreover, the communication link 178 can be established using a remote network 198. The remote network 198 can be a datacenter, a private network, a distributed network, a cloud (e.g., cloud 150), etc. The communication link 178 can also be established using other, intermediary networks, such as a public network (i.e., the Internet), which can interconnect the clouds 174, 176 with or without the remote network 198.

First cloud 174 and second cloud 176 can include cloud gateway 225 and cloud gateway 235, respectively, and at least one virtual machine (VM). For example, first cloud 174 can include VM1 250 and VM2 252, and second cloud 176 can include VM3 254 (and/or nested VM containers). The cloud gateway 225 can be configured as a VM running in the first cloud 174 that is responsible to establish communication link 270 for interconnecting the components in the second cloud 176 with the first cloud 174. The cloud gateway 235 may be configured as a VM running in the second cloud 176 that is responsible to establish the communication link 270 for connecting the cloud gateway 235 with cloud resources.

First cloud 174 can include a virtual supervisor module 190, a hypervisor 180 (also called a virtual machine manager or monitor), and one or more VMs 182. Virtual supervisor module 190 can be used to create VMs in the cloud. Each of the VMs can host an application or service, and can operate as if each resides in the cloud.

Hypervisor 180 can be configured by the virtual supervisor module 190, and can provide an operating system for one or more VMs. Hypervisor 180 can include computer software, firmware, and/or hardware to create and/or run one or more VMs. Moreover, hypervisor 180 can run one or more VMs on one or more computers called host machines. Each of the VMs can be referred to as a guest machine, and can run a guest operating system.

First cloud 174 can also include a hybrid cloud manager 184, which can be a management plane VM for auto-provisioning resources in a hybrid cloud solution. The hybrid cloud manager 184 can be a management platform (which can include physical or virtual components, such as a VM) running in the first cloud 174, and can be generally responsible for providing hybrid cloud operations, translating between cloud interfaces, management of cloud resources, dynamic instantiating of cloud gateways and cloud VM components (e.g., VM 182, 196) through virtualization platform and cloud provider APIs, for example. The hybrid cloud manager 184 may also monitor components (e.g., the cloud gateways 188, 192, one or more private application VMs, communication link 198, etc.) and/or manage those components.

Each cloud or network can include switch and/or network infrastructure for providing features and network services such as switching network traffic locally at the cloud, providing consistent enterprise network polices, allowing insertion or provisioning of various network services (e.g., load balancers, firewalls, content servers, web services, voice and data services, etc.). For example, first cloud 174 can include router 186 and second cloud 176 can include router 194 for routing traffic between cloud components or devices and/or within the network fabric. Moreover, the switch and/or network infrastructure can form a network topology, such as a spine-leaf or folded CLOS topology, which can include one or more switches, routers, segments, servers, domains, tenants, etc.

Communication link 198 can take several forms. For example, communication link 198 can include, or can be established via, remote network 198 and/or any other network, such as a public network (e.g., the Internet), a private network (e.g., a LAN), or a combination thereof. Communication link 198 can also include a virtual private network (VPN) or tunnel, a point-to-point link, a pseudowire, a virtual circuit, etc., as previously noted.

The communication link 198 can offer secure transport connections between the clouds. Moreover, the communication link 198 can be based on tunneling or point-to-point technologies which can provide customers inter or intra-datacenter network connectivity and various network topologies. Such technologies can also extend the network (e.g., cloud or enterprise datacenter) at the network layer (Layer 3 or “L3” of the OSI model). Networks created at a cloud or datacenter (e.g., second cloud 176) can include new subnets, segments, overlays, and VMs to extend a different cloud or datacenter. Specific services or applications (e.g., access control lists, firewall policies, domain name services, etc.) can be accordingly configured or modified in order for attached VM systems to communicate through the underlay and/or between clouds.

Some cloud embodiments can utilize a secure transport layer (e.g., Layer 4 or “L4”) tunnel as the communication link 178 between a first cloud gateway 188 in the first cloud 174 and a second cloud gateway 192 in the second cloud 176. The secure transport layer tunnel can be configured to provide a link layer (e.g., Layer 2 or “L2”) network extension between the first cloud 174 and the second cloud 176. The secure transport layer (L4) tunnel (e.g., transport layer security (TLS), datagram TLS (DTLS), secure socket layer (SSL), etc.) can provide a secure L2 switch overlay that interconnects cloud resources (e.g., second cloud 176) with other clouds, networks or datacenters (e.g., first cloud 174, enterprise networks or datacenters, etc.). In other words, the secure transport layer tunnel can provide a link layer network extension between the first cloud 174 and the second cloud 176.

Cloud gateway 188 at the first cloud 174 can use the communication link 178 to connect to cloud resources allocated at the second cloud 176, and vice versa. The link 178 can be used with corporate or private firewalls and NAT devices due to the nature of the transport level protocols (e.g., UDP/TCP) and the transport layer ports opened for HTTP/HTTPS in the firewall, for example. Underlying L2 networks can be further extended and connected to each of the cloud VMs through the cloud gateways 188, 192.

Cloud service providers can offer a number of network attachments for each of the cloud VMs and resources, such as networking or data processing capabilities. Cloud service provides can provide one or more types of services, such as software as a service, infrastructure as a service, platform as a service, backend as a service, desktop as a service, or information technology management as a service.

As described above, the techniques herein can allow customers to deploy network architectures and interconnections between clouds or networks. As one of ordinary skill in the art will readily recognize, the interconnection model 172 can include other architectures, networks, carriers, providers, components, resources, links, devices, or clouds. Indeed, interconnection model 172 is provided as a non-limiting example for simplicity and explanation purposes.

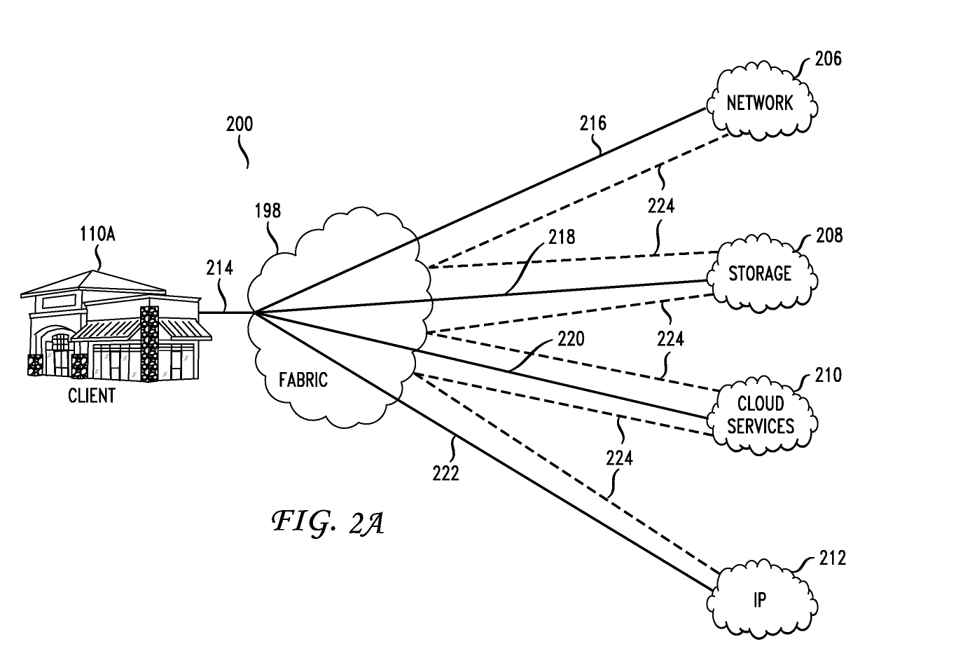

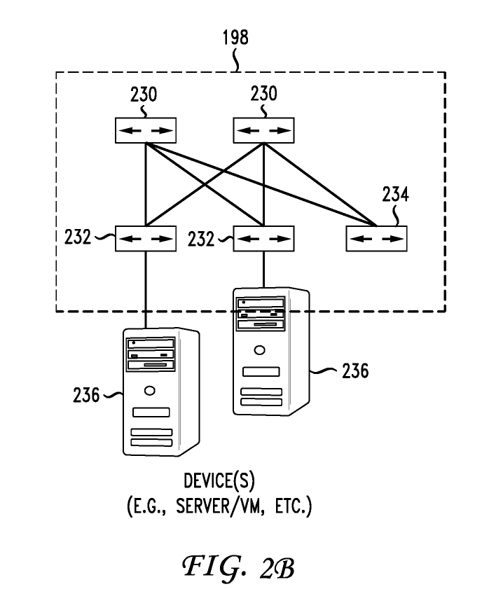

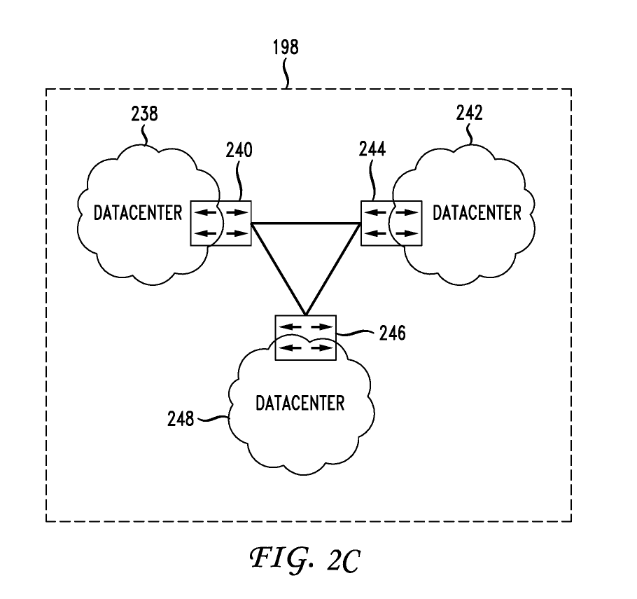

FIG. 2A illustrates a schematic diagram of an example system 200 for interconnecting networks. Client 110A (e.g., endpoint, enterprise, network, campus, datacenter, etc.) can connect to fabric 198 to establish one or more links 216-224 to one or more endpoints 206-212. Fabric 198 can include one or more private and/or public networks. For example, fabric 198 can include a datacenter, a cloud, or a cluster of private networks. Moreover, fabric 198 can include physical resources for establishing, monitoring, configuring, managing, and/or troubleshooting the one or more links 216-224.

The one or more links 216-224 can be virtual links or circuits to the endpoints 206-212. For example, the links 216-224 can be dedicated or point-to-point links or tunnels to the endpoints 206-212. To illustrate, link 216 can be an MPLS pseudowire connecting client 110A with endpoint 206.

Endpoints 206-212 can include clouds (e.g., public clouds, private clouds, hybrid clouds), carriers, service providers, networks, datacenters, etc. For example, endpoint 206 can be a network provider, endpoint 208 can be a storage provider, endpoint 210 can be a cloud services provider, and endpoint 212 can be a voice and data services provider. Moreover, endpoints 206-212 can provide services to, or extend current services from, client 110A. For example, endpoints 206-212 can provide additional bandwidth services, cloud bursting services, or media services to client 110A and/or consumers of services from client 110A.

FIG. 2B illustrates an example configuration of a fabric 198 for provisioning services and interconnecting networks. Fabric 198 can include switches 230 and 232 configured according to a specific topology, such as spine-leaf or folded CLOS, for communicating within the fabric 198. Switches 230 and 232 can serve as the underlay of the network. Moreover, switches 232 can interface with one or more devices 236, such as servers, VMs, controllers, and so forth. Fabric 198 can also include a gateway 234, which can serve as an ingress/egress router for connecting the fabric 198 with other networks, devices, or clouds. Fabric 198 can also include capabilities for establishing virtual circuits, links, or tunnels to other networks, and managing or routing traffic to and from other networks.

FIG. 2C illustrates a second example configuration of a fabric 198 for provisioning services and interconnecting networks. Fabric 198 can include multiple networks or datacenters 238, 242, 248. The networks or datacenters 238, 242, 248 can be interconnected within the fabric 198 via respective routers 240, 244, 246. One or more of the respective routers 240, 244, 246 can also connect the networks or datacenters 238, 242, 248 to other networks or devices outside of the fabric 198. This way, the networks or datacenters 238, 242, 248 can communicate with other networks and devices outside of the fabric 198.

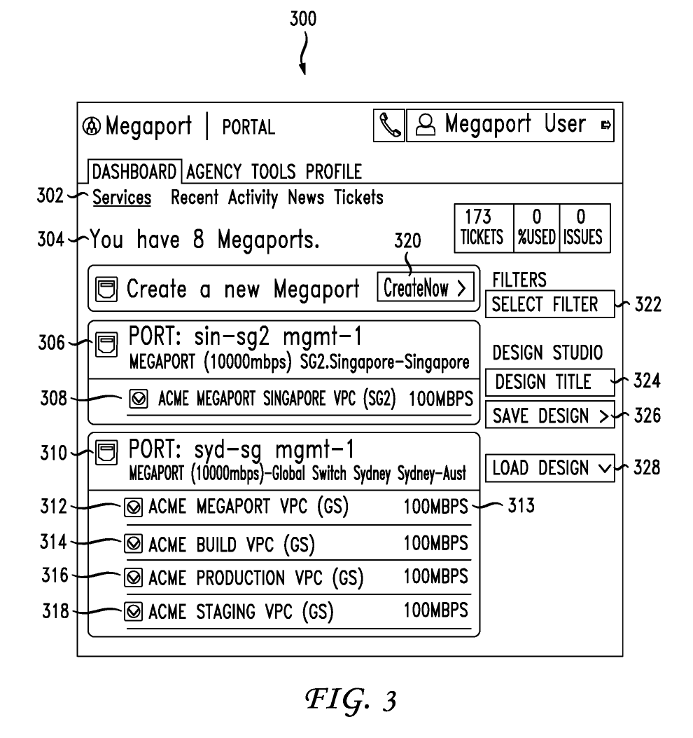

FIG. 3 illustrates an example user interface 300 which may be utilized by some embodiments of the present technology. User interface 300 can be associated with a technology that provides a control interface for comparing and adding cloud-based services from a multitude of cloud service providers. This can allow users to compare costs, speeds, resources, and routing paths, for example, of various cloud service providers.

User interface element 302 illustrates a dashboard display utilized by some embodiments. The dashboard display tab 302 may include network services currently associated with a user. Non-limiting examples of services can include number of provisioned network ports (e.g., Megaports® provided by Megaport® (Services) Pty Ltd. of Brisbane, Queensland, Australia) available 304, provisioned network ports 306 and 310, and virtual circuits 308 and 312-318. A provisioned network port (e.g., a Megaport®), as used herein, can include a network port provided by a network service provider (e.g., Megaport® (Services) Pty Ltd.) to a user to enable network connectivity between a first endpoint (e.g., a network, a colocation data center, etc.) and one or more second endpoints (e.g., remote networks, cloud service providers, internet service providers, etc.).

A user can request a network port from a network service provider, modify a configuration of the provisioned network port, add/remove one or more virtual circuits, modify a respective configuration of the virtual circuits, among other tasks. The network service provider can configure an underlying physical network fabric to provision the network port according to the user's specified network configuration and request parameters. User interface 300 may be associated with a network of a user, such as the user's private or enterprise network. Provisioned network ports 306 and 310 may be listed along with their respective virtual circuits 308 and 312-318 in order to give a user a quick view of their general network configuration. Information related to provisioned network ports 306 and 310 and virtual circuits 308 and 312-318 may be listed such as, for example, rate limit 313, location of the provisioning or network port server (e.g., Megaport® server), maximum rate limit available from each network port, and other data pertaining to configuration of a network.

Interface element 320 may allow a user to create a new provisioned network port (e.g., Megaport®) by selecting the user interface element 320. Furthermore, user interface element 322 can be represented by a drop-down menu or similar feature in order to filter among various options for network configuration, such as, for instance, cost, location of provisioned network port, rate limit, bandwidth size, or routing paths. User interface element 324 can allow a user to enter a title or description for a user-designed network configuration. This user-designed network configuration may be saved for later use by selecting button 326. This can provide time savings and convenience for a user who wishes to compare various network configurations and decide which one to utilize or purchase. This may also be convenient for a user who wishes to quickly select and implement a previously-saved, user-designed network configuration. In some embodiments, the present technology may also provide predictive suggestions based on user data such as bandwidth or budget, in order to provide automatically-generated network configurations for a user.

Embodiments of the present technology can improve network routing efficiency and associated computing hardware by providing faster and more efficient network routing of data, which in turn would require fewer computing cycles for a processor and thereby increase the life of the processor itself. User interface element 328 may allow a user to implement a previously-saved network configuration template/design that was created by the user or automatically created by embodiments of the present technology to suggest more efficient or cost-effective network configurations based on user data.

The features described in user interface 300 are non-limiting examples of options available in an embodiment of the present technology. One of ordinary skill in the art will readily recognize that user interface 300 can include more or less features than those depicted in FIG. 3. Moreover, one of ordinary skill in the art will readily recognize that user interface 300 can include other configurations and layouts. Likewise, other control interfaces (e.g., command-line interface, application, API, etc.) described in the present application may contain more or fewer features than are shown in the example drawings, and features may be arranged differently or use various colors or visual features to implement various embodiments of the present technology.

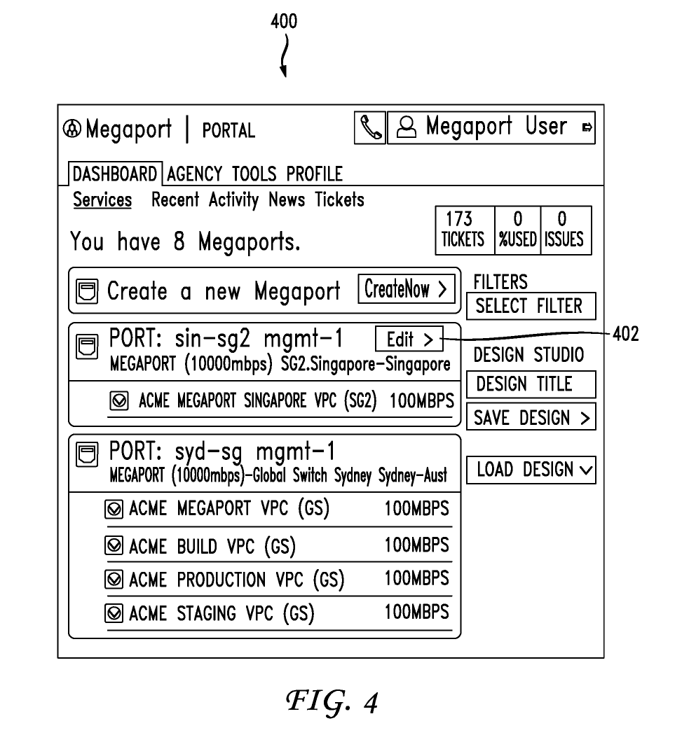

FIG. 4 illustrates an example user interface 400 which may be utilized by some embodiments of the present technology. User interface element 402 can be a selectable button or element that may be presented to a user upon, for example, selecting a provisioned network port name that the user wishes to edit or configure. Button 402 may allow the user to view additional details related to the selected provisioned network port such as port name, location of the provisioned network port, bandwidth amount, rate limit, and cost for services.

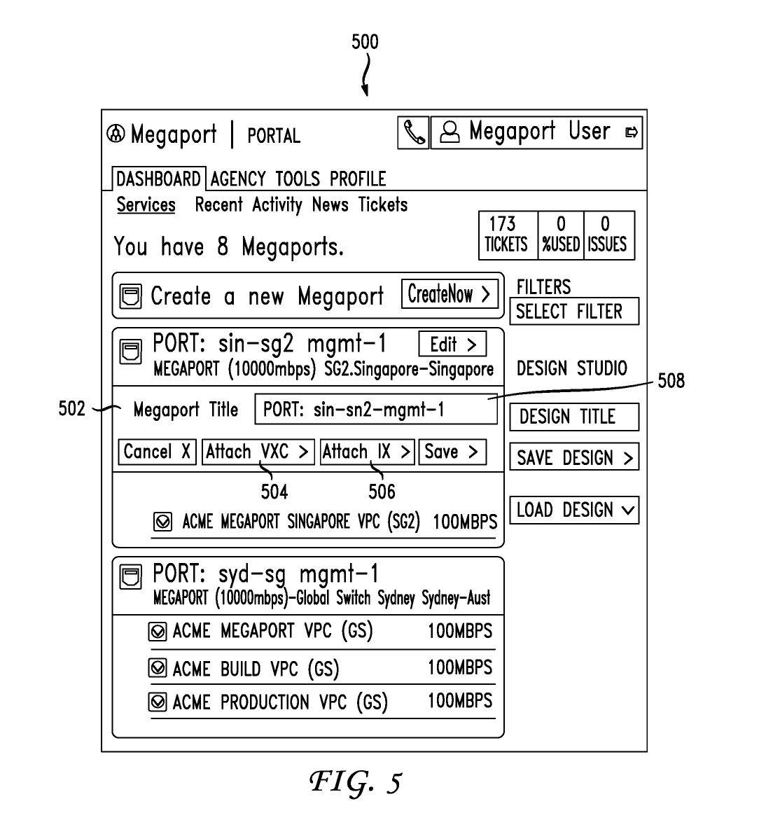

FIG. 5 illustrates an example user interface 500 which may be utilized by some embodiments of the present technology. After a user selects element 402 to begin editing a desired provisioned network port, user interface 500 may be presented. User interface element 502 may provide an interactive display to a user for configuring a desired provisioned network port. Button 504 can be selected to add a virtual circuit to the user's provisioned network port. A virtual circuit can be an abstraction of a network connection from a first endpoint to one or more second endpoints. In this example, selecting button 504 corresponds to a request for a point-to-point network connection between endpoints or networks. In some embodiments, the point-to-point network connection is a Virtual Cross Connect (VXC®) provided by Megaport® (Services) Pty Ltd. VXC can be a direct connection between two or more network ports, such as a direct Ethernet connection between network ports. A VXC can thus allow high speed, private, and/or secure connectivity between endpoints. A VXC can be configured as a pseudowire, such as an MPLS pseudowire, in increments of bandwidth between network ports. A VXC can allow use of a network port interface to connect to one or more service providers, clouds, enterprises, datacenters, etc.

A VXC can be configured as a private, point-to-point Ethernet pseudowire presented as a VLAN between network ports. VXCs can support Q-in-Q and may be transparent to other protocols. As previously noted, VXCs can also be configured in bandwidth increments (e.g., 1 Mbps, 10 Mbps, 100 Gbps, etc.).

Button 506 may be selected to configure a point-to-multi-point network connection, such as a connection between an endpoint and multiple endpoints, such as a network service provider, a public cloud-based network, an enterprise network, etc. In some embodiments, the point-to-multi-point network connection is a Megaport Internet Exchange (MegaIX®) provided by Megaport® (Services) Pty Ltd. The point-to-multi-point network connection can connect an endpoint to another endpoint through an Internet exchange, which can provide connectivity and services across multiple geographies. The Internet exchange can include various users or networks peering on the Internet exchange to form a peering community.

For example, a user may view his/her network and wish to add services to his/her network. The user may desire to change only a provisioned network port associated with Singapore, as shown in FIG. 5 at 502. The user may update the title 508 or description associated with the provisioned network port 502, or add additional bandwidth capability to the network. The user can also create a point to multi-point connection associated with the provisioned network port 502. To this end, the user may select button 506 to attach a virtual circuit to the provisioned network port 502.

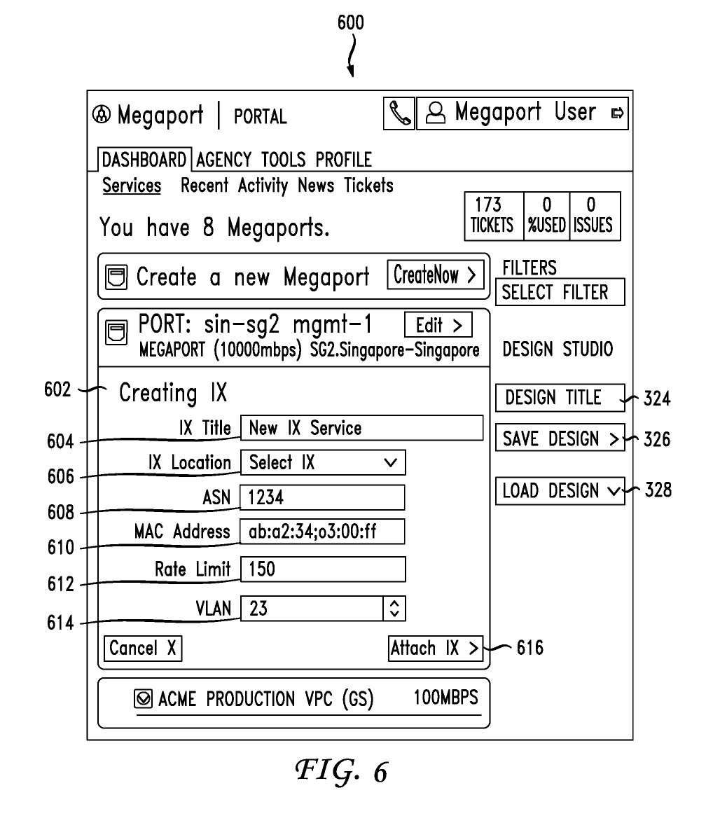

Upon selection of button 506, a user interface as illustrated in FIG. 6 may be presented. FIG. 6 shows an embodiment of a user interface 600 for configuring a virtual circuit corresponding to a point-to-multi-point network connection. Window 602 may appear upon selecting button 506 and can provide multiple interactive fields for configuring the virtual circuit. User interface 600 can include a title 604 that the user may create to refer to the virtual circuit. User interface element 606 can allow a user to configure a desired location for the point-to-multi-point network connection. User interface element 608 may allow a user to configure an autonomous system number associated with the virtual circuit. User interface element 610 can allow a user to input a media access control address to be associated with the virtual circuit and the corresponding provisioned network port. User interface element 612 can permit a user to enter a desired rate limit, and user interface element 614 may allow a user to configure a virtual local area network number for the virtual circuit.

After making entries into fields 604-614, the user may attach the configured virtual circuit to its corresponding provisioned network port. If the user wishes to save the virtual circuit configuration for future use, such as for sharing with a third party user or for future implementation on the user's system, the user can enter a name for the user-designed virtual circuit configuration in field 324. Upon selection of button 326, the design may be saved for future use under the name entered in field 324. To load a previously saved design/template, the user may select from, for example, a drop down menu 328 which can provide access to display multiple previously-saved network configuration templates.

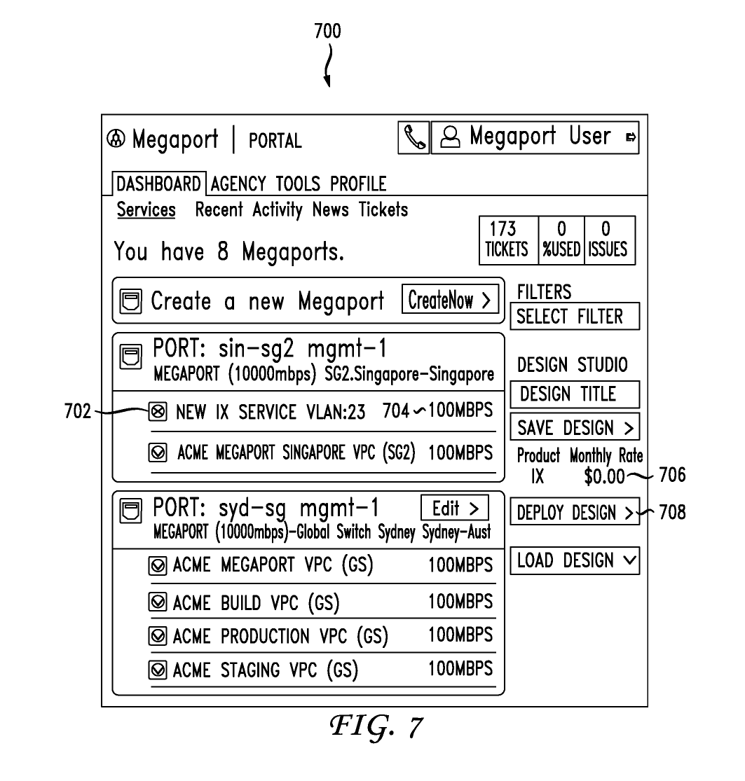

FIG. 7 illustrates an example user interface 700 that may be presented after creating a point-to-multi-point network connection configuration template and saving it by selecting, for example, button 326. User interface element 702 shows a new point-to-multi-point service displayed in line with its corresponding provisioned network port. New service 702 may be the user-configured template from FIG. 6, and may include a visually distinguishable icon to alert the user that the new service is selected but has not yet been provisioned. Non-limiting examples of a visually distinguishable icon may be a unique design, a unique color, a unique animation, etc., associated with the visual representation of the new service 702. User interface element 704 shows the added bandwidth rate limit associated with the new service 702. The VLAN number associated with the new service 702 can also be displayed. It is noted that other details associated with the new service 702 may be displayed in place of, or in addition to, bandwidth rate and VLAN number.

User interface element 706 illustrates a monthly cost associated with the new service 702. It is noted that other cost measurements may be utilized such as daily rates, weekly rates, usage rates, etc. Furthermore, cost associated with new network services may be expressed in any currency and may be determined by a user or automatically determined by the system. For example, embodiments of the present technology may determine that the user is located in the United States and therefore utilize the United States dollar as the currency for calculating costs of services. User interface element 708 may be a selectable button that allows a user to proceed to the next step in the service purchasing process, i.e., proceeding to a checkout screen to confirm selection of services and payment for services.

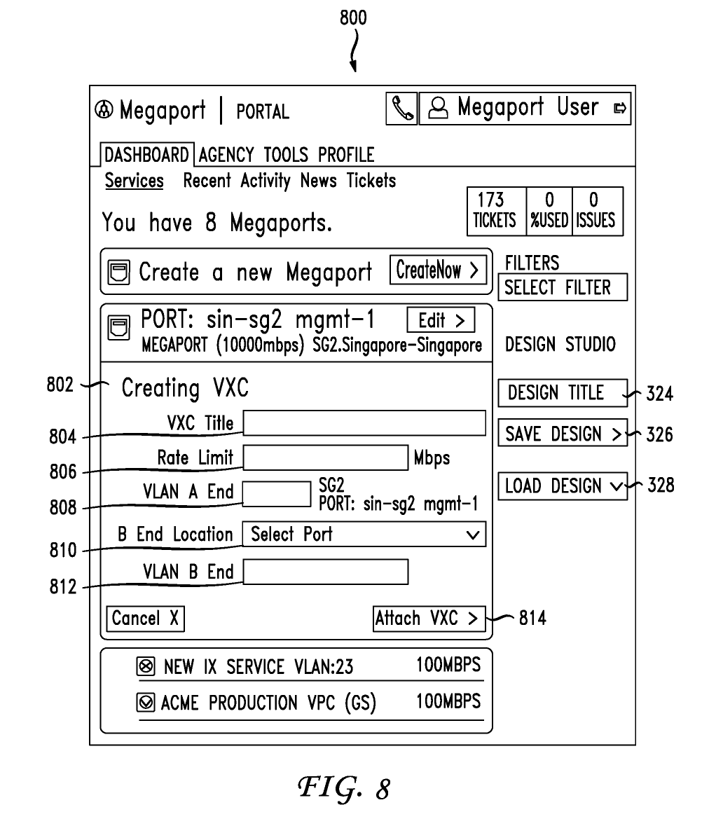

FIG. 8 shows an embodiment of a user interface 800 for configuring a virtual circuit corresponding to a point-to-point network connection. If a user wishes to make an endpoint to endpoint connection via, for example, a virtual circuit or link, the user can select button 504 as illustrated in FIG. 5. Upon selection of button 504, user interface 800 as illustrated in FIG. 8 may be presented. Window 802 may appear upon selecting button 504 and can provide multiple interactive fields for configuring a virtual circuit or link. User interface 800 can include a title field 804 that the user may create to refer to this point-to-point network connection. User interface element 806 can allow a user to configure the rate limit they desire for their point to point network connection. Interactive field 808 may allow a user to configure a VLAN A End endpoint associated with the point-to-point network connection. Interactive field 810 can allow a user to configure a VLAN B End location associated with the point-to-point network connection. Interactive field 810 may be represented by a drop down menu of available B End Locations. Interactive field 812 can allow a user to configure a VLAN B End endpoint associated with the point-to-point connection.

After making entries into fields 804-812, the user may add the configured virtual circuit to its corresponding provisioned network port by selecting button 814. If the user wishes to save the virtual circuit configuration/template for future use, such as for sharing with a third party or for future implementation on the user's system, the user can enter a name for the user-designed virtual circuit configuration/template in field 324. Upon selection of button 326, the design may be saved for future use under the name entered in field 324. To load a previously saved design/template, the user may select from, for example, a drop down menu 328 which can provide access to display multiple previously-saved network configuration templates.

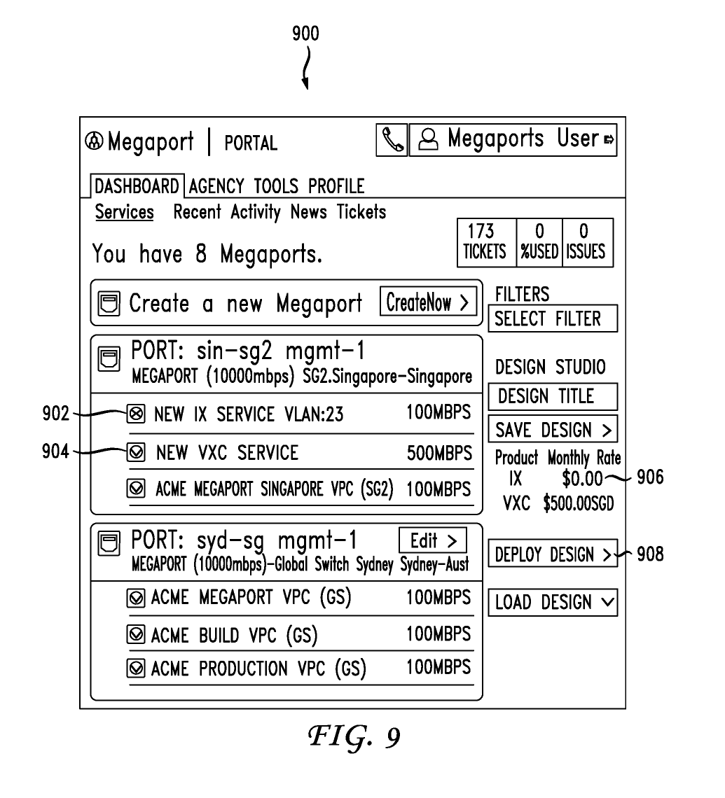

FIG. 9 illustrates an example user interface 900 that may be utilized by some embodiments. After creating and selecting new service 902 and new service 904, the newly created services can be displayed in line with and under their corresponding provisioned network ports. A visually distinguishing feature or icon may be applied to new services 902 and 904 to show that the services have been selected but not yet paid for or implemented with the user's network. Examples of visually distinguishing features may be a unique icon, unique color, or unique font to distinguish the titles of the new services from the services already applied to the user's network. FIG. 9 illustrates an embodiment where new virtual circuits or services 902 and 904 are under the same provisioned network port, but it is understood that new virtual circuits or network services may be listed under different provisioned network ports if appropriate. Field 906 displays the cost of the selected new virtual circuits or services 902 and 904. In some embodiments, button 908 may allow a user to deploy the new virtual circuits or services 902 and 904 by adding them to the user's current network services after confirmation of services desired and payment.

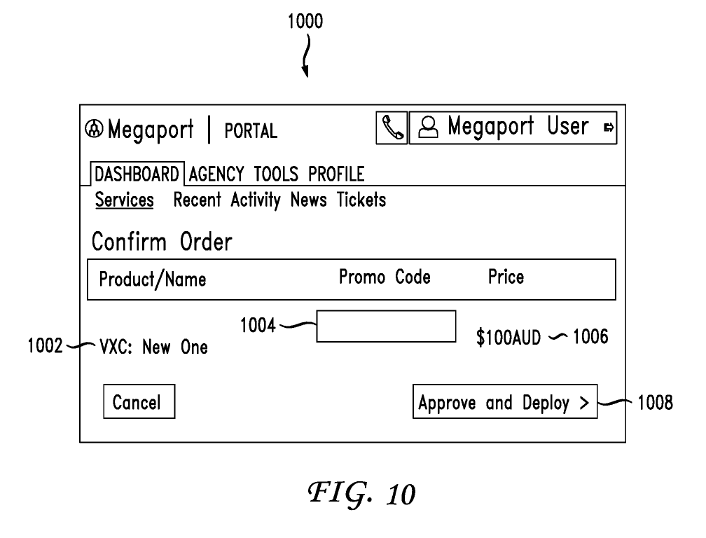

FIG. 10 illustrates an example user interface 1000 that may be utilized by some embodiments. After selecting button 908 as illustrated in FIG. 9, the user interface 1000 can be presented in order to confirm services desired and payment for costs associated with the desired services. User interface element 1002 lists an item/service, in this case a point-to-point network connection, to be added to a user's existing network. Interactive field 1004 can allow a user to provide a promotional code to apply, for example, a discount or promotional offer to the desired service 1002. User interface element 1006 may display the cost of the service 1002 in one or more currencies. Button 1008 may be utilized to approve the addition of network service 1002 and payment. In some embodiments, upon selection of button 1008, service 1002 may be deployed/added to the user's existing network services.

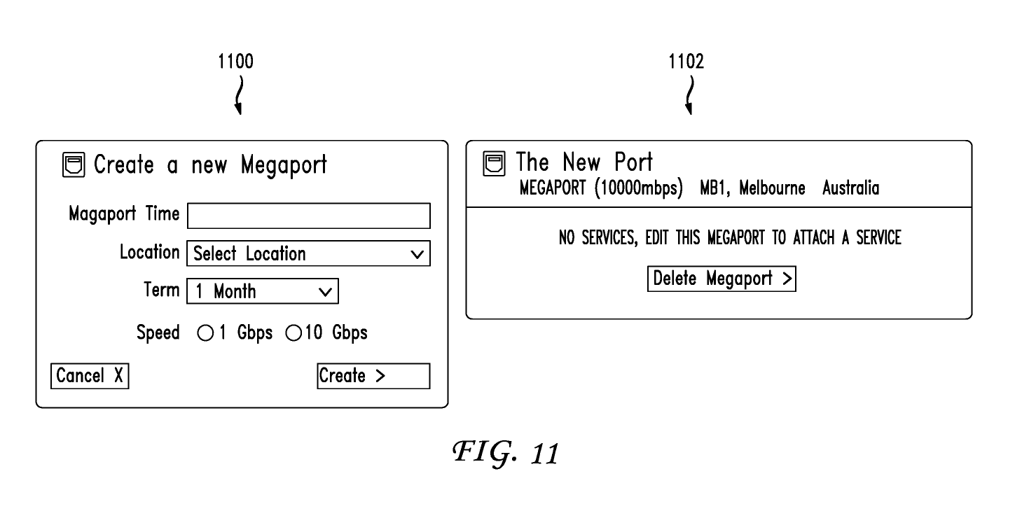

FIG. 11 illustrates example user interfaces 1100 and 1102. In some embodiments, a user of an enterprise network may desire to create a new provisioned network port, such as a Megaport® provided by Megaport® (Services) Pty Ltd. User interface 1100 can allow the user to create a new provisioned network port as a pending/incomplete service that may be ready to have virtual circuits, resources, or services attached to it. For example, user interface 1100 can allow a user to create a title for the provisioned network port, select from a list of locations for the provisioned network port, select a term of service, select speed of network connection, or any other parameter for the provisioned network port. User interface 1102 can allow a user to delete a selected provisioned network port.

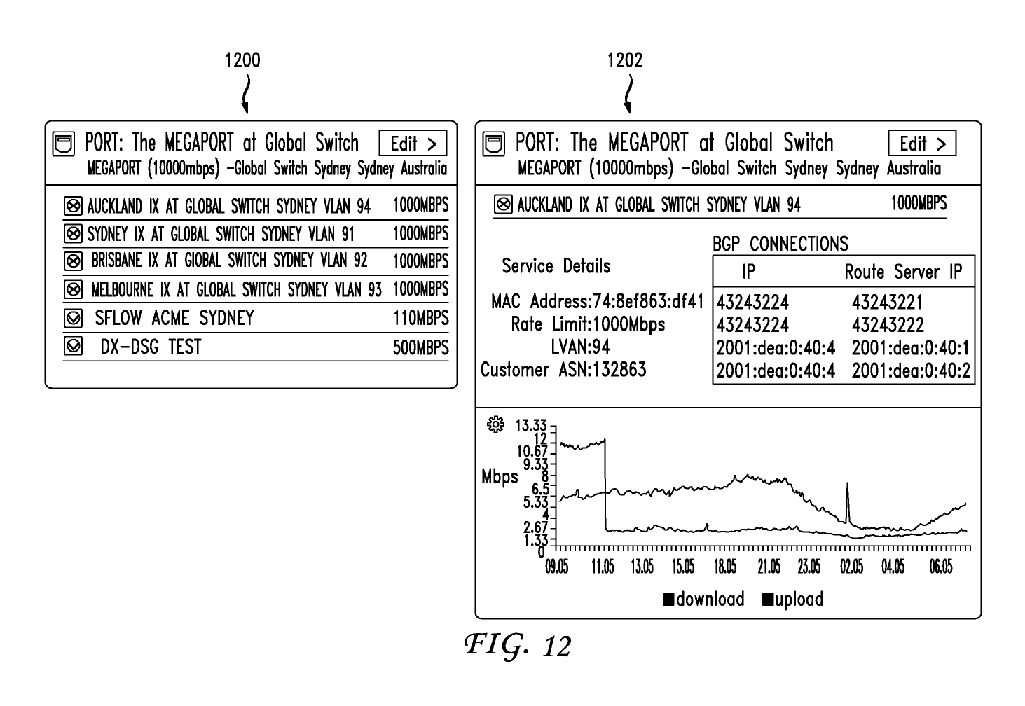

FIG. 12 illustrates example user interfaces 1200 and 1202. In some embodiments, user interface 1200 can list virtual circuits or network services that are active on a user's account. Information related to the active virtual circuits or services may also be displayed on user interface 1200. Examples of information related to the active virtual circuits or services may be location of a provisioned network port, name of public cloud service provider (e.g., AWS®, Azure®, Google Cloud Platform®, etc.), type of connection (e.g., IX, VXC, etc.). User interface 1200 shows one provisioned network port and multiple circuits/services attached to the provisioned network port. However, some embodiments may display multiple provisioned network ports with their respective virtual circuits or services listed in line. Furthermore, a user may select each virtual circuit or service icon to learn additional information regarding each virtual circuit or service. For example, user interface 1202 shows additional information displayed regarding the first virtual circuit or service listed under the provisioned network port of user interface 1200. Additional information may include service details such as MAC address, rate limit, VLAN number, Customer ASN, Border Gateway Protocol connection data, IP addresses, download/upload speeds, server address information, routing information, network statistics, and the like.

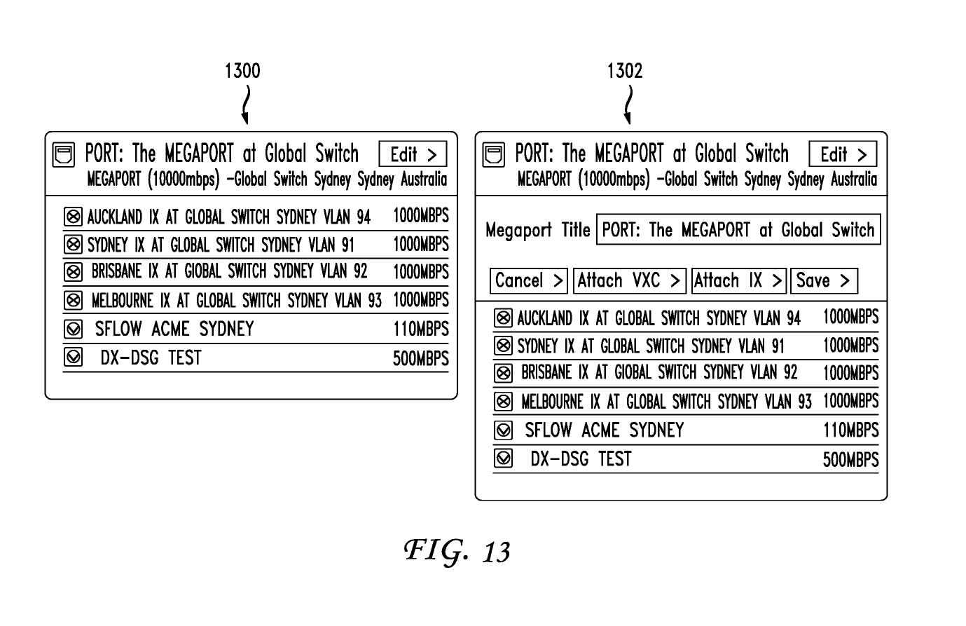

FIG. 13 illustrates example interfaces 1300 and 1302 according to some embodiments. Interface 1300 can show a provisioned network port with the virtual circuits or services associated with that provisioned network port. Each provisioned network port may be configured individually, and editing user interface 1302 can be displayed in line within the user interface 1300. User interface 1302 may allow a user to edit the title of the desired service and attach a new virtual circuit service (e.g., VXC® or MegaIX®) to an existing provisioned network port.

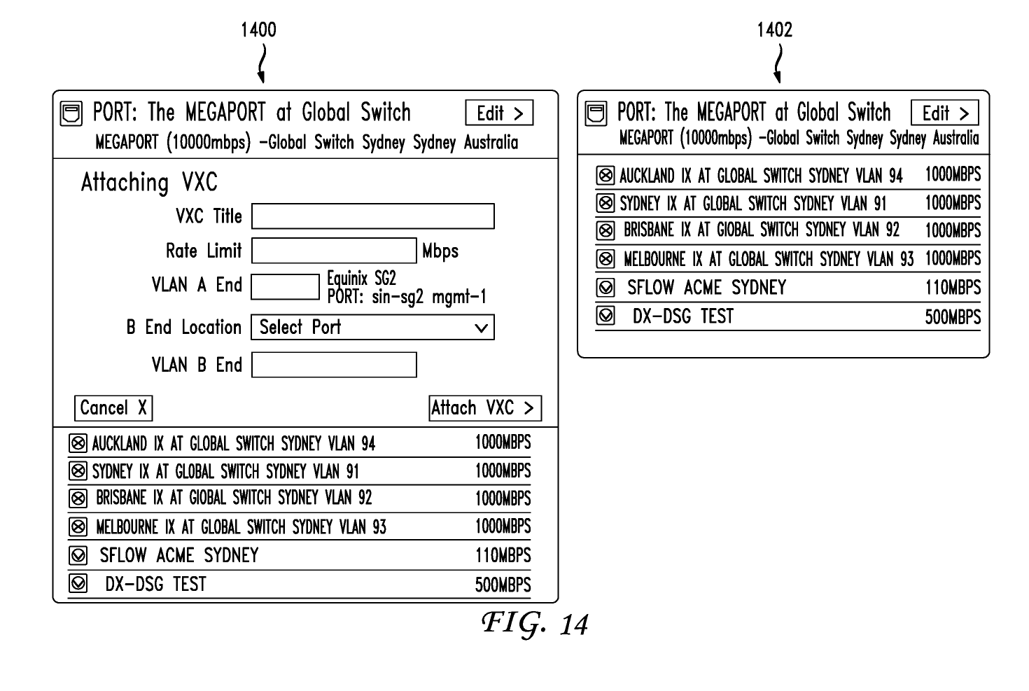

FIG. 14 shows example interfaces 1400 and 1402 according to some embodiment. Interface 1400 can allow a user to add a service/virtual circuit to his/her existing provisioned network port. After entering service configuration specifics into interface 1400, the new desired service can appear in interface 1402 as “New Attached Service” or any other name that the user desires. The new service/virtual circuit may be visually distinguishable from the active services in interface 1402 by, for example, utilizing a unique color or unique icon to correspond with the new service. This visual distinguishing graphical element may alert a user to the fact that the new service may be configured, but not yet deployed/activated and merely awaiting confirmation and activation by the user for implementation with the user's active network.

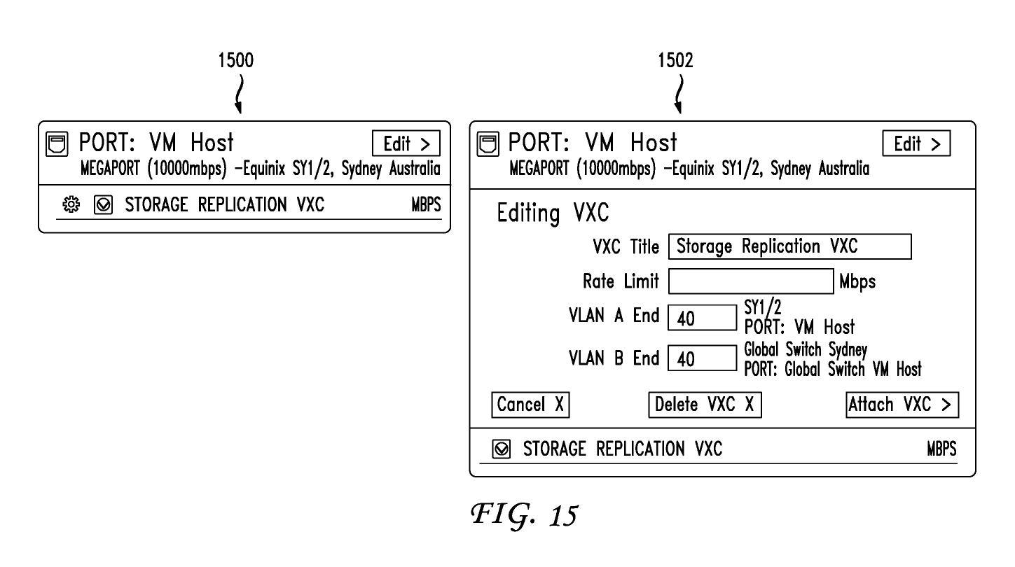

In some embodiments, each network service/virtual circuit provided can be configured in line with a list of active, configured, and partially-configured services. Active services can be updated in real time and incomplete/pending services may be amended to be deployed with the user's active network when the user is ready. FIG. 15 illustrates example interfaces 1500 and 1502. Interface 1500 shows a provisioned network port with a virtual circuit to a storage replication service. Upon selecting an edit option associated with interface 1500, interactive interface 1502 may be presented to allow the user to configure the selected service. The user may configure the virtual circuit by entering parameters for the virtual circuit in interactive interface 1502. The user can also have the option to cancel updates, delete the virtual circuit, or save changes.

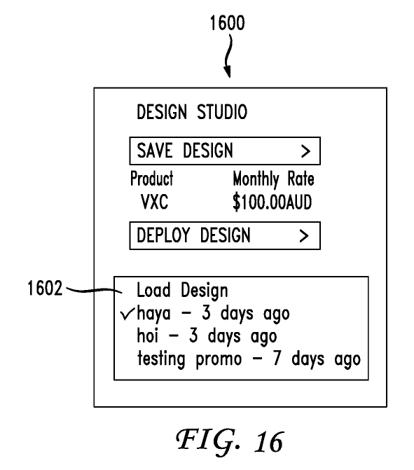

FIG. 16 shows an example user interface 1600 for saving and deploying a network configuration. User interface 1600 can allow a user to save a network configuration at any point in the configuration process. This may allow a user to design a network configuration, save his/her work under any name, and retrieve his/her work under the designated name in order to complete the network configuration at a later time. The designated name may appear in, for example, a drop-down list of names 1602 associated with other network configuration templates that may have been previously saved. Moreover, the user may deploy the design for implementation with the user's network and/or deploy the design for sharing with a third party. For example, the user can design a VXC® template and share that template with a colleague for use on the colleague's network.

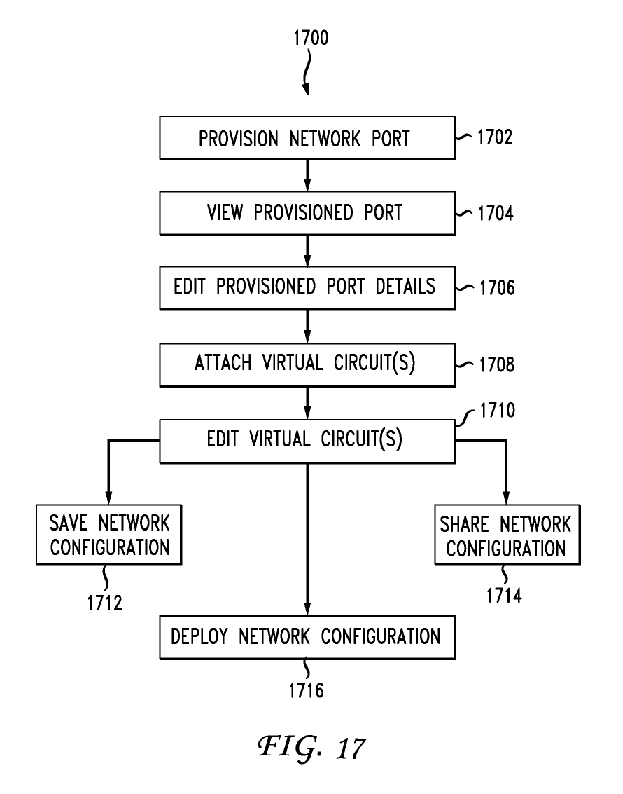

FIG. 17 illustrates an example process 1700 which may be utilized by some embodiments of the present technology. At step 1702, a network service provider (e.g., Megaport® (Services) Pty Ltd. may provision a network port for a user/customer. At 1704, the user may view details regarding network configuration of his/her provisioned network port. Assuming the user wishes to add, delete, or modify provisioned network port services/configuration, process 1700 may continue with the user editing parameters of the provisioned network port at step 1706. Assuming the user desires to add, delete, or modify virtual circuits to his/her existing network services, process 1700 can proceed with the user attaching one or more virtual circuits to his/her physical port at step 1708. Process 1700 may continue at step 1710 with the user editing the virtual circuits for the reason of, for example, utilizing a cheaper virtual circuit than currently used. The user may then save the network configuration 1712, share the network configuration with one or more entities 1714, and/or deploy the network configuration 1716 for immediate use.

It should be noted that certain steps within process 1700 may be optional, and the steps shown in FIG. 17 are merely examples for illustration as steps may be included or excluded as desired. Further, while a particular order of the steps is shown, this ordering is merely illustrative, and any suitable arrangement of the steps may be utilized without departing from the scope of the embodiments described herein.

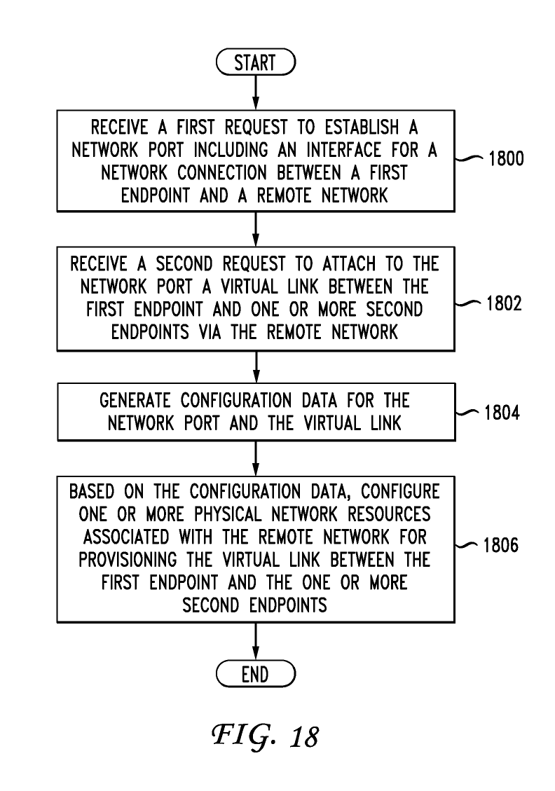

Having disclosed some basic system components and concepts, the disclosure now turns to the example method embodiment shown in FIG. 18. For the sake of clarity, the method is described in terms of a controller 155, as shown in FIGS. 1A-B, configured to practice the method. The steps outlined herein are exemplary and can be implemented in any combination thereof, including combinations that exclude, add, or modify certain steps.

At step 1800, controller 155 can receive a first request to establish a network port including an interface for a network connection between a first endpoint and a remote network. The network port can be can be associated with one or more virtual circuits for connecting the first endpoint and the remote network. The first endpoint can be, for example, an enterprise, a consumer, a network, a carrier, a cloud, a datacenter, etc. The first endpoint can be associated with one or more physical and/or virtual network resources for provisioning the network port. For example, the first endpoint can be client 110A as shown in FIG. 2A. The remote network can include a campus, a datacenter, a network, a cloud, etc. For example, the remote network can be fabric 198 as shown in FIG. 2A. The remote network can include multiple networks or a cluster of resources. For example, the remote network can include a peering community of networks or clients.

At step 1802, controller 155 can receive a second request to attach to the network port a virtual link between the first endpoint and one or more second endpoints via the remote network. For example, the system can receive a request to attach to the network port a virtual circuit between a first endpoint, such as an enterprise network or a cloud, and a second endpoint, such as a network or cloud provider, via a datacenter or fabric associated with the first endpoint. The virtual link can provide a virtual point-to-point connection, such as a pseudowire (e.g., MPLS or IP pseudowire) or a tunnel (e.g., virtual tunnel or circuit), for example. The one or more second endpoints can include a network, a carrier, a cloud, a datacenter, a campus, a provider, etc. For example, the one or more second endpoints can be endpoints 206-212 as shown in FIG. 2A.

At step 1804, controller 155 can generate configuration data for the network port and the virtual link. The configuration data can include parameters for establishing the network port and/or virtual link. For example, the configuration data can define hardware resources and corresponding parameters, such as addressing, routing, resource, control, management, scheduling, service, QoS, protocol, security, transport, physical, data link, application, session, presentation, labeling, software, and/or networking parameters, associated with the network port and/or virtual link. Controller 155 can generate the configuration data automatically in response to the first and second requests. For example, controller 155 can generate the configuration data automatically when the user submits a request via a GUI to create the network port and/or attach the virtual link or a corresponding service.

Based on the configuration data, at step 1806, controller 155 configures one or more physical network resources for provisioning the virtual link between the first endpoint and the one or more second endpoints. By configuring the physical network resources, controller 155 can establish the virtual link between the first endpoint and the one or more second endpoints. Controller 155 can also provision or enable resources associated with the one or more second endpoints based on the virtual link.

Controller 155 can configure the physical network resources automatically in response to the first and second requests. Controller 155 can also generate the configuration data and configure the physical network resources automatically in response to a purchase event, such as an input from a user for purchasing the network port, the virtual link, and/or a service associated with the one or more second endpoints. The purchase can be facilitated via a GUI, which can be used by a user to submit the first and second requests, as well as any parameters associated with the network port, the virtual link, and/or the service. The purchase can be made on a subscription basis (e.g., daily, weekly, monthly, etc.), on a schedule, a term, or any other payment model, such as pay per usage.

The GUI can be an interactive display configured to enable a user to interact with the controller 155 and/or remote network to configure access to resources hosted by the one or more second endpoints through the remote network or using resources associated with the remote network. The GUI can allow a user to provide inputs for configuring virtual circuits, adding or configuring services, and/or interconnecting remote networks, datacenters, providers, services, clouds, etc. The GUI can include form fields for entering inputs, editing options, network characteristics, parameters, preferences, etc. It will be appreciated by one of ordinary skill in the art that various other embodiments may employ various other types of control interfaces, such as a command-line interface or an API, among other possibilities.

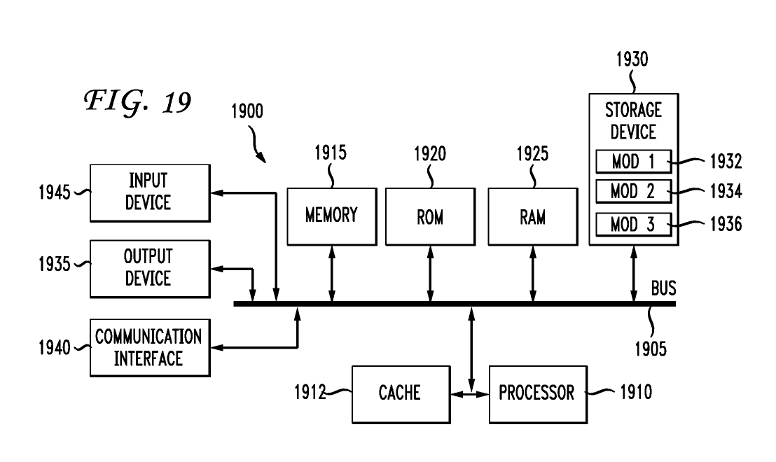

FIG. 19 illustrates an example system architecture that can be utilized by some embodiments of the present technology. Persons of ordinary skill in the art will readily appreciate that other system embodiments are possible.

FIG. 19 illustrates a bus computing system architecture 1900 wherein the components of the system are in electrical communication with each other using a bus 1905. Exemplary system 1900 includes a processing unit (CPU or processor) 1910 and a system bus 1905 that couples various system components including the system memory 1915, such as read only memory (ROM) 1920 and random access memory (RAM) 1925, to the processor 1910. The system 1900 can include a cache of high-speed memory connected directly with, in close proximity to, or integrated as part of the processor 1910. The system 1900 can copy data from the memory 1915 and/or the storage device 1930 to the cache 1912 for quick access by the processor 1910. In this way, the cache can provide a performance boost that avoids processor 1910 delays while waiting for data. These and other modules can control or be configured to control the processor 1910 to perform various actions. Other system memory 1915 may be available for use as well. The memory 1915 can include multiple different types of memory with different performance characteristics. The processor 1910 can include any general purpose processor and a hardware module or software module, such as module 1 1932, module 2 1934, and module 3 1936 stored in storage device 1930, configured to control the processor 1910 as well as a special-purpose processor where software instructions are incorporated into the actual processor design. The processor 1910 may essentially be a completely self-contained computing system, containing multiple cores or processors, a bus, memory controller, cache, etc. A multi-core processor may be symmetric or asymmetric.

To enable user interaction with the computing system architecture 1900, an input device 1945 can represent any number of input mechanisms, such as a microphone for speech, a touch-sensitive screen for gesture or graphical input, keyboard, mouse, motion input, speech and so forth. An output device 1935 can also be one or more of a number of output mechanisms known to those of skill in the art. In some instances, multimodal systems can enable a user to provide multiple types of input to communicate with the computing device 1900. The communications interface 1940 can generally govern and manage the user input and system output. There is no restriction on operating on any particular hardware arrangement and therefore the basic features here may easily be substituted for improved hardware or firmware arrangements as they are developed.

Storage device 1930 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1925, read only memory (ROM) 1920, and hybrids thereof.

The storage device 1930 can include software modules 1932, 1934, 1936 for controlling the processor 1910. Other hardware or software modules are contemplated. The storage device 1930 can be connected to the system bus 1905. In one aspect, a hardware module that performs a particular function can include the software component stored in a computer-readable medium in connection with the necessary hardware components, such as the processor 1910, bus 1905, display 1935, and so forth, to carry out the function.

It can be appreciated that example system 1900 can have more than one processor 1910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, media, and memories can include a cable or wireless signal containing a bit stream and the like. However, when mentioned, non-transitory computer-readable storage media exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rack mount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim. Further, features described with reference to an embodiment disclosed herein can be combined with, or implemented in, any other embodiments disclosed herein.

The techniques disclosed herein can provide increased privacy among endpoints communicating via a cloud-based network which may result in more efficient network packet processing as fewer data may be required for network packet transmissions, which may result in fewer processor cycles required to route signals and thus improved efficiency of the network processors used to implement some embodiments of the present technology.

While there have been shown and described illustrative embodiments of the present technology, it is to be understood that various other adaptations and modifications may be made within the spirit and scope of the embodiments herein. For example, the embodiments have been shown and described herein with relation to a particular communication system. However, the embodiments in their broader sense are not as limited, and may, in fact, be used with any number of communication systems.

Further, although the foregoing description has been directed to specific embodiments, it will be apparent that other variations and modifications may be made to the described embodiments, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code.

Examples of computer-readable media that may be used to store instructions, information used, and/or information created during methods according to described examples include cloud-based media, magnetic or optical disks, flash memory, USB devices provided with non-volatile memory, networked storage devices, and the like. In addition, devices implementing methods according to these disclosures can comprise hardware, firmware and/or software, and can take any of a variety of form factors. Typical examples of such form factors include laptops, smart phones, tablets, wearable devices, small form factor personal computers, personal digital assistants, and the like. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving a first request to establish a network port comprising an interface for a dedicated network connection between a first endpoint and a remote network;
receiving a second request to attach to the network port a virtual link between the first endpoint and one or more second endpoints of the remote network;
generating configuration data for the network port and the virtual link; and
based on the configuration data, configuring one or more physical network resources for provisioning the virtual link between the first endpoint and the one or more second endpoints.

2. The method of claim 1, wherein the one or more second endpoints are associated with at least one of a cloud service provider or a public network.

3. The method of claim 2, further comprising:
establishing the virtual link between the first endpoint and the one or more second endpoints, the virtual link including a point-to-point virtual link.

4. The method of claim 3, further comprising:
provisioning one or more resources associated with the one or more second endpoints via the point-to-point virtual link.

5. The method of claim 3, wherein the point-to-point virtual link includes a Multiprotocol Label Switching (MPLS) pseudowire.

6. The method of claim 1, wherein the first endpoint is associated with a colocation datacenter, and the one or more physical network resources are hosted by the colocation datacenter.

7. The method of claim 1, further comprising:
providing a control interface for receiving the first request and the second request and one or more parameters associated with the network port and the virtual link.

8. The method of claim 7, wherein the control interface interfaces with the remote network to enable automated configuration of the one or more physical network resources.

9. The method of claim 8, wherein the one or more second endpoints are associated with a cloud service provider, and the method further comprises:
enabling a user to interact with the remote network to configure access to resources hosted by the cloud service provider.

10. The method of claim 8, wherein the control interface includes an interactive display, and the method further comprises:
receiving input for provisioning the virtual link.

11. The method of claim 10, further comprising:
providing form fields associated with the virtual link in the interactive display; and
providing editing options for network characteristics of the virtual link via the form fields.

12. The method of claim 11, wherein the editing options include at least one of a first option to add the virtual link, a second option to edit the virtual link, or a third option to remove the virtual link, and the network characteristics include at least one of a network bandwidth or an indication of a specific cloud service network or a public network associated with the one or more second endpoints.

13. The method of claim 12, wherein the interactive display includes an option to purchase the network service and an indication of a cost associated with the network service.

14. A system comprising:
a processor; and
a computer-readable storage medium having stored thereon instructions which, upon being executed by the processor, cause the system to:
receive a first request to establish a network port comprising an interface for a dedicated network connection between a first endpoint and a remote network;
receive a second request to attach to the network port a virtual link between the first endpoint and one or more second endpoints of the remote network;
generate configuration data for the network port and the virtual link; and
based on the configuration data, configure one or more physical network resources for provisioning the virtual link between the first endpoint and the one or more second endpoints.

15. The system of claim 14, wherein the virtual link includes an MPLS pseudowire, and the one or more second endpoints are associated with at least one of a cloud service provider or a public network.

16. The system of claim 15, wherein the computer-readable storage medium includes additional instructions which, upon being executed by the processor, further cause the system to:
provide a control interface for receiving the first request and the second request and one or more parameters associated with the network port and the virtual link.

17. The system of claim 16, wherein the control interface interfaces with the remote network to enable automated configuration of the one or more physical network resources based on one or more inputs received via form fields of the control interface, and the computer-readable storage medium includes additional instructions which, upon being executed by the processor, further cause the system to:
provide editing options for network characteristics of the virtual link via the form fields,
wherein the editing options include at least one of a first option to add the virtual link, a second option to edit the virtual link, or a third option to remove the virtual link, and the network characteristics include at least one of a network bandwidth or an indication of a specific cloud or network provider associated with the one or more second endpoints.

18. A computer-readable storage device having stored therein instructions which, upon being executed by a processor, cause the processor to:
receive a first request to establish a network port comprising an interface for a dedicated network connection between a first endpoint and a remote network;
receive a second request to attach to the network port a virtual link between the first endpoint and one or more second endpoints of the remote network;
generate configuration data for the network port and the virtual link; and
based on the configuration data, configure one or more physical network resources for provisioning the virtual link between the first endpoint and the one or more second endpoints.

19. The computer-readable storage device of claim 18, wherein the first endpoint is associated with a colocation datacenter, the one or more physical resources are hosted by the colocation datacenter, the one or more second endpoints are associated with at least one of a cloud service provider or a public network, and the computer-readable storage medium stores additional instructions which, upon being executed by the processor, further cause the processor to:
provide a control interface for receiving the first request and the second request and one or more parameters associated with the network port and the virtual link.

20. The computer-readable storage device of claim 19, the computer-readable storage medium stores additional instructions which, upon being executed by the processor, further cause the processor to:
receive input for provisioning the virtual link via form fields of the control interface; and
provide editing options for network characteristics of the virtual link via the form fields,
wherein the editing options including at least one of a first option to add the virtual link, a second option to edit the virtual link, or a third option to remove the virtual link, and the network characteristics include at least one of a network bandwidth or an indication of a specific cloud service provider or public network associated with the one or more second endpoints.
